(19) United States
(12) Patent Application Publication
(10) Pub. No.: US 2001/0034951 A1
(43) Pub. Date: Nov. 1, 2001

(54) Alignment tool apparatus and method

(76) Inventor: John E. Sears, Spanaway, WA (US)

Correspondence Address: WILLIAM G. FORSTER, LAW OFFICES, WILLIAM G. FORSTER, P.O. BOX 577, SUMNER, WA, 98390, US

(21) Appl. No.: 09/809,776

(22) Filed: Mar. 16, 2001

Related U.S. Application Data
(60) Provisional application No. 60/190,239, filed on Mar. 17, 2000.

(51) Int. Cl. B23Q 17/22; B27G 23/00

(52) U.S. Cl. 33/640; 33/645

(57) ABSTRACT

The invention is an alignment tool for precisely aligning a workpiece to the saw blade of a cutting tool so that as the saw blade and the workpiece are brought together, the predetermined plane of cut through the workpiece, as defined for example by scribe lines on the workpiece, is aligned with the saw blade cutting plane as defined by the leading cutting edge of the saw blade. The alignment tool comprises an alignment head that is spaced from the saw blade. Extending or projecting from the alignment head is at least one alignment element disposed for engagement with the workpiece along the predetermined plane of cut through the workpiece. In order to secure the alignment head in position, a support arm is disposed between the saw blade and the alignment head. The support arm attaches to the alignment head to support the same in spaced relation from the saw blade, wherein the alignment head is adjustable in a direction parallel with the saw blade cutting plane. In this way, the alignment edge can be disposed adjacent the workpiece for positioning the same to align the predetermined plane of cut with the saw blade cutting plane. In addition, the support arm is removable mounted to the saw blade.

This application claims the benefit of U.S. Provisional Application No. 60/190,239 filed Mar. 17, 2000.

### BACKGROUND

This invention relates generally to cutting tools that employ circular saw blades for cutting material, and more particularly to devices adapted to precisely align a workpiece so that the predetermined plane of cut through the same is aligned to the cutting plane of the saw blade.

Alignment tools for aligning saw blades to tools, and for aligning a workpiece to the cutting plane of a saw blade are known in the art. Many of the early designs were directed to measuring saw blade alignment with the tool that supported the blade. For example U.S. Pat. No. 3,628,496 issued in 1971 discloses a height gauge for measuring the height of circular saw blades for precisely setting the height of the same in relation to the tool. In addition, in 1980, U.S. Pat. No. 4,218,826 issued disclosing a radial arm saw alignment tool for checking the alignment of radial arm saw blades relative to the saw table.

A few of the later designs were directed to saw blade workpiece alignment. For example in 1989, U.S. Pat. No. 4,843,728 issued disclosing a saw guide for guiding the saw along the different guide surfaces of the saw guide to form multiple cut location indicators. Also, in 1991 U.S. Pat. No. 5,014,443 issued showing a radial arm saw alignment device that facilitated the proper alignment of radial arm saws through the use of perpendicular and parallel components.

Further, in 1992, U.S. Pat. No. 5,107,600 issued disclosing a parallel measuring guide device for setting a rip fence in connection with a table saw or drill press by measuring alignment and minimum spacing of two objects. Similarly, U.S. Pat. No. 5,197,365 issued in 1993 illustrating a measuring apparatus for miter saws for measuring the distance of a workpiece from the blade of a saw. In 1993, U.S. Pat. No. 5,207,007 issued showing a set-up-tool including a dial indicator that extends from a miter slot to a blade of a power saw to measure distance between the same. In 1994 U.S. Pat. No. 5,353,515 issued disclosing a precision rip fence alignment gauge for positioning a rip fence a precise distance from the saw blade.

Other recent designs include U.S. Pat. No. 5,400,518 issued in 1995 disclosing a redial arm saw alignment device that aligns the saw blade in relation to the saw table, and U.S. Pat. No. 5,491,906 issued in 1996 showing a master gage which is employed for setting a cutting tool or saw blade with respect to the reference surface. Also, in 1997, U.S. Pat. No. 5,632,096 issued disclosing a saw blade alignment tool for setting the angular relationship of a circular saw blade in relation to the work surface.

While most the above noted alignment tools perform some alignment technique of saw blades, they are primarily directed to aligning the saw blade to the tool that supports the same. Moreover, most alignment tools directed to alignment of the workpiece to the cutting tool are, to some extent, either complicated in design and difficult to use, or expensive to manufacture, and in addition they produce imprecise results. Accordingly, a need remains for an alignment tool for precise saw blade to workpiece alignment that is simple in construction, easy to use, and inexpensive.

### SUMMARY

One object of the invention is to precisely align a saw blade with the predetermined plane of cut through a work piece.

A second object is to minimize wasted material that is rejected as the result of a poor cut by a saw blade is imprecisely aligned with a work piece.

Another object is to increase the efficiency of a user by increasing the number of work pieces that can be precisely cut in a given amount of time.

Yet another object is to reduce injuries to a user by simplifying the precise positioning and set-up of a workpiece to a saw blade.

A further object is to increase the accuracy of a variety of tools that employ circular saw blades as cutting tools.

Still another object is to extend the useful life of a saw blade by reducing the number of cuts required to precisely cut a workpiece along a predetermined plane of cut.

The invention is an alignment tool for precisely aligning a workpiece to the saw blade of a cutting tool so that as the saw blade and the workpiece are brought together, the predetermined plane of cut through the workpiece, as defined for example by scribe lines on the workpiece, is aligned with the saw blade cutting plane. Importantly, the saw blade cutting plane is defined by one of the opposing planar/parallel saw blade surfaces and the leading cutting edge thereof.

The alignment tool comprises an alignment head that is spaced from the saw blade, and adjacent the workpiece when the alignment tool is mounted to a saw blade. Extending or projecting from the alignment head is at least one alignment element disposed for engagement with the workpiece along the predetermined plane of cut through the workpiece. In one embodiment, each alignment element comprises an alignment edge disposed on and defined by the alignment head for alignment of the workpiece to the alignment edge. With this arrangement, the workpiece is so aligned by first determining the predetermined plane of cut through the workpiece, which can be indicated for example by scribe lines provided on the workpiece. Following this a user can then position the workpiece so that the alignment edge extends on and along the predetermined plane of cut, i.e., along the scribe line.

As will be more fully discussed in the specification, the workpiece is generally placed on a substantially horizontal work surface and is therefore only rotatable (about a vertical axis) within the horizontal plane defined by the work surface. Accordingly, adjustment of the saw blade's tilt angle, i.e., tilt along an axis parallel to the saw blade cutting plane, may be necessary to enable proper alignment of the alignment edge to extend on and along the predetermined plane of cut through the workpiece. As such, both the workpiece and the saw blade must, at times depending on the particular cut, be arranged to precisely position the alignment edge along the predetermined plane of cut through the workpiece. For example, this situation occurs when the predetermined cut involves a compound miter.

In order to secure the alignment head in position, a support arm is disposed between the saw blade and the alignment head. Specifically, the support arm attaches to the alignment head to support the same in spaced relation from the saw blade, wherein the alignment head is movable, i.e., adjustable in a direction parallel with the saw blade cutting plane. In this way, the alignment edge can be disposed adjacent the workpiece for positioning the same to align the predetermined plane of cut with the saw blade cutting plane. Moreover, means for removably mounting or fixing the support arm from the saw blade is provided.

Finally the arrangement of the alignment tool calls for each alignment edge to lie substantially along and on the saw blade cutting plane when the support arm is mounted to the saw blade. In this way, each alignment edge is precisely aligned with the predetermined plane of cut through the workpiece thereby aligning the predetermined plane of cut with the saw blade cutting plane.

The foregoing and other objects, features, and advantages of this invention will become more readily apparent from the following detailed description of a preferred embodiment which proceeds with reference to the accompanying drawings, wherein the preferred embodiment of the invention is shown and described, simply by way of illustration of the best mode contemplated of carrying out the invention. As will be realized, the invention is capable of other and different embodiments, and its several details are capable of modifications in various obvious respects, all without departing from the invention. Accordingly, the drawings and description are to be regarded as illustrative in nature, and not as restrictive.

### BRIEF DESCRIPTION OF THE DRAWINGS

FIG. 1 is a perspective view of an alignment tool mounted to a saw blade with the alignment edge of the alignment head resting on the table of a table saw, wherein the dashed lines illustrate a range of positioning of the parts thereof.

FIG. 2 is a is a perspective view of an alignment tool.

FIG. 3 is a plan view of an alignment tool with the dashed line illustrating the plane of the mounting surface of a mounting base/magnetic assembly being substantially aligned with the alignment edge of the alignment head.

FIG. 4 is an elevational view illustrating an alignment tool mounted to a saw blade that is tilted in relation to the saw table.

FIG. 5 is a perspective view illustrating an alignment tool mounted to a tilted saw blade wherein the alignment edge of the alignment head is placed against a protractor resting on the saw table to measure the angle of tilt of the saw blade in relation to the table.

FIG. 6 is a cross sectional view of a magnetic assembly taken along 6-6 in FIG. 3.

FIG. 7 is an exploded perspective view illustrating the components of an alignment tool.

FIG. 8 is a perspective view of an alternate embodiment alignment tool illustrating an alignment edge of the alignment tool aligned with a scribe line marked on a workpiece.

FIG. 9 is an exploded perspective view of an alternate embodiment alignment tool illustrating the components thereof.

FIG. 10 is a perspective view of an alternate embodiment alignment tool illustrating an alignment head fixed to a first link of a support arm.

FIG. 11 is a perspective view of a connection bore disposed through a first link of a support arm.

FIG. 12 is a elevational view of an alternate embodiment alignment tool secured to a saw blade of a table saw wherein the alignment tool comprises a support arm having a first and second link, and an alignment head having an alignment edge contacting the top surface of a workpiece.

FIG. 13 is a elevational view of an alternate embodiment alignment tool secured to a saw blade of a table saw wherein the alignment tool comprises a support arm having a first and second link, and an alignment head having an alignment edge contacting the back surface of workpiece.

FIG. 14 is an elevational view of an alternate embodiment alignment tool secured to a saw blade of a radial arm saw wherein the alignment tool comprises a support arm having a first and second link, and an alignment head having an alignment edge contacting the back surface of workpiece.

FIG. 15 is an elevational view of an alternate embodiment alignment tool secured to a saw blade of a compound miter saw wherein the alignment tool comprises a support arm having a first link, and an alignment head having an alignment edge contacting the back surface of workpiece.

FIG. 16 is a perspective view illustrating an alignment tool mounted to a tilted saw blade wherein the alignment edge of the alignment head is placed along the scribe line marked on the back surface of a workpiece wherein the broken lines indicate alternate positions of the alignment edge on the top surface of the workpiece.

FIG. 17 is an elevational view illustrating an alternate embodiment alignment tool that employs a laser, wherein the dashed line illustrates the plane, i.e., line of the light emitted by the laser directed to engage the top and back surfaces of the workpiece.

FIG. 18 is a plan view of an alternate embodiment alignment tool that employs a laser, wherein the dashed line illustrates the plane of the mounting surface of a mounting base/magnetic assembly being substantially aligned with the plane of light emitted by the laser.

FIG. 19 is an exploded fragmentary perspective view of an alternate embodiment alignment tool illustrating the connection between the first and second links thereof, wherein a keyhole panel rivet is employed as the fastener.

### DETAILED DESCRIPTION OF PREFERRED EMBODIMENT

Indicated generally at 20 is an alignment tool constructed in accordance with the present invention. The alignment tool 20 is adapted for precisely aligning a workpiece 22 to the saw blade 24 of a cutting tool 26 so that as the saw blade 24 and the workpiece 22 are brought together, the predetermined plane of cut 28 through the workpiece 22, as defined for example by scribe lines on the workpiece 22, is aligned with the saw blade cutting plane 30. Importantly, the saw blade cutting plane 30 is defined by one of the opposing parallel, planar saw blade surfaces 32-34 and the leading cutting edge 36-38 thereof.

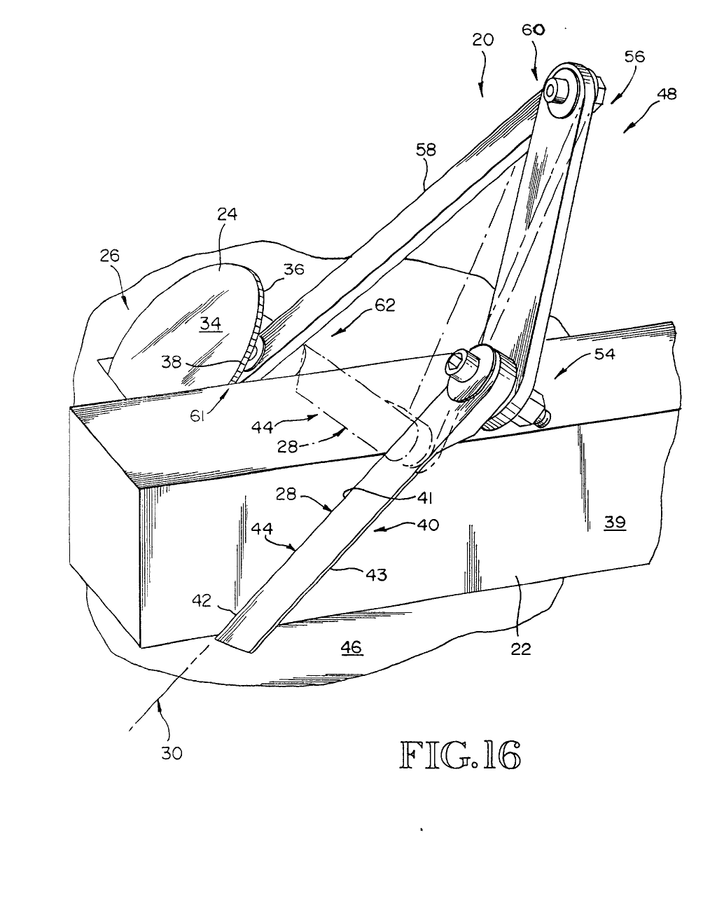

The alignment tool 20 comprises an alignment head 40 that is spaced from the saw blade 24, and adjacent the workpiece 22 when the alignment tool 20 is mounted to a saw blade 24. Extending or projecting from the alignment head 40 is at least one alignment element 41 along the predetermined plane of cut 28 through the workpiece 22. In one embodiment, the alignment element 41 comprises an alignment edge 42 that is disposed on and defined by the alignment head 40 for alignment of the workpiece 22 to the alignment edge 42. With this arrangement, the workpiece 22 is so aligned by first determining the predetermined plane of cut 28 through the workpiece 22, which can be indicated for example by scribe lines 44 (FIG. 16) drawn on the workpiece 22. Following this, a user (not illustrated) can then position the workpiece 22 so that the alignment edge 42 extends on and along the predetermined plane of cut 28, i.e., the scribe line(s) 44.

As will be more fully discussed in the following, the workpiece 22 is typically placed on a substantially horizontal work surface 46 and is therefore only rotatable, about a vertical axis, within the horizontal plane defined by the work surface 46. Accordingly, adjustment of the saw blade's tilt angle, i.e., tilt along an axis parallel to the saw blade cutting plane, may be necessary to enable proper alignment of the alignment edge 42 to extend on and along the predetermined plane of cut 28 through the workpiece 22. As such, both the workpiece 22 and the saw blade 24 must, at times depending on the particular cut, be arranged to precisely position the alignment edge 42 along the predetermined plane of cut 28 through the workpiece 22. For example, this situation occurs when the predetermined cut involves a compound miter cut.

In order to secure the alignment head 40 in position, a support arm 48 is magnetically fixed to the saw blade 24, and extends from the saw blade 24 to the alignment head 40. Specifically, the support arm 48 attaches to the alignment head 40 to support the same in spaced relation from the saw blade 24, wherein the alignment head 40 is movable, i.e., adjustable in a direction parallel with the saw blade cutting plane 30. In this way, the alignment edge 42 can be disposed adjacent the workpiece 22 for positioning the same to align the predetermined plane of cut 28 with the saw blade cutting plane 30. Moreover, in the preferred embodiment, magnetic means for removably mounting/fixing the support arm 48 from the saw blade 24 is provided.

Finally the arrangement of the alignment tool 20 calls for each alignment edge 42-43 to lie substantially along and on the saw blade cutting plane 30 when the support arm 48 is mounted to the saw blade 24. In this way, for example, alignment edge 42 can be precisely aligned with the predetermined plane of cut 28 through the workpiece 22 thereby aligning the predetermined plane of cut 28 with the saw blade cutting plane 30.

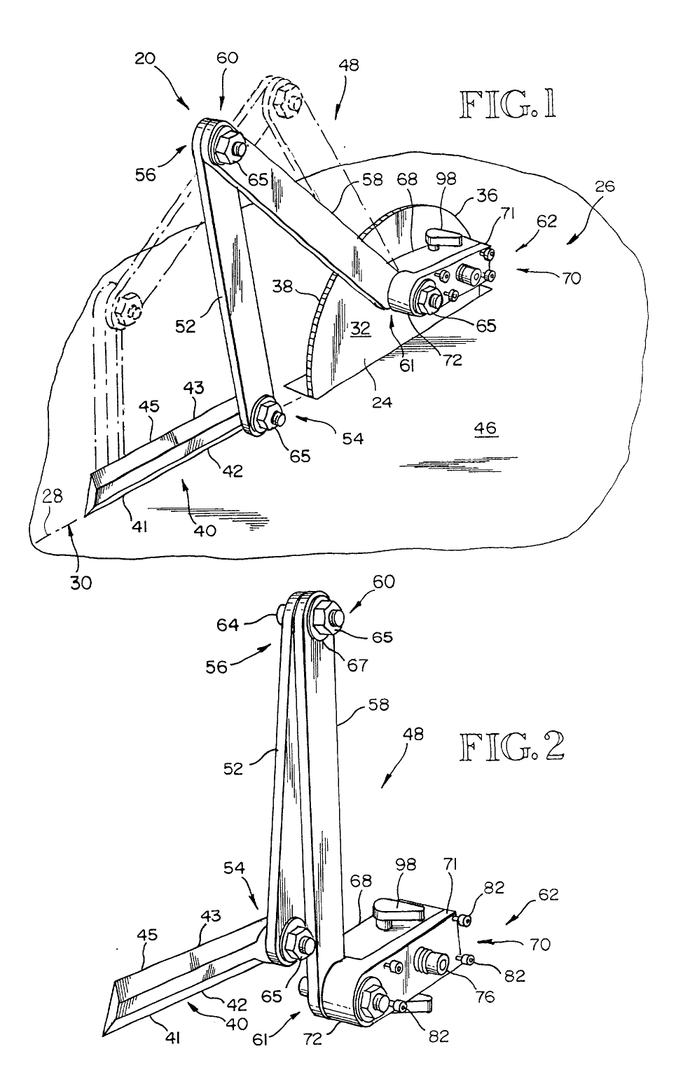

Considering now in more detail the structure of the components from which the preferred embodiment alignment tool 20 is constructed, the alignment head 40 comprises two alignment elements 41 and 45 that project therefrom to define two alignment edges 42-43 as illustrated in FIGS. 1 and 2. The alignment head 40 is constructed from a solid piece of aluminum or steel with opposing beveled (chamfered) surfaces that form the alignment elements 41 and 45. It should be understood that although many of the components of an alignment tool are made from steel or metal, other materials such as plastic could be employed with equally satisfactory results. The opposing alignment elements 41, 45 define respectively opposing alignment edges 42, 43. Although the alignment edges 42-43 are substantially parallel, they could be transversely disposed, relative to one another, as will be discussed and illustrated more completely in the following description of an alternate embodiment.

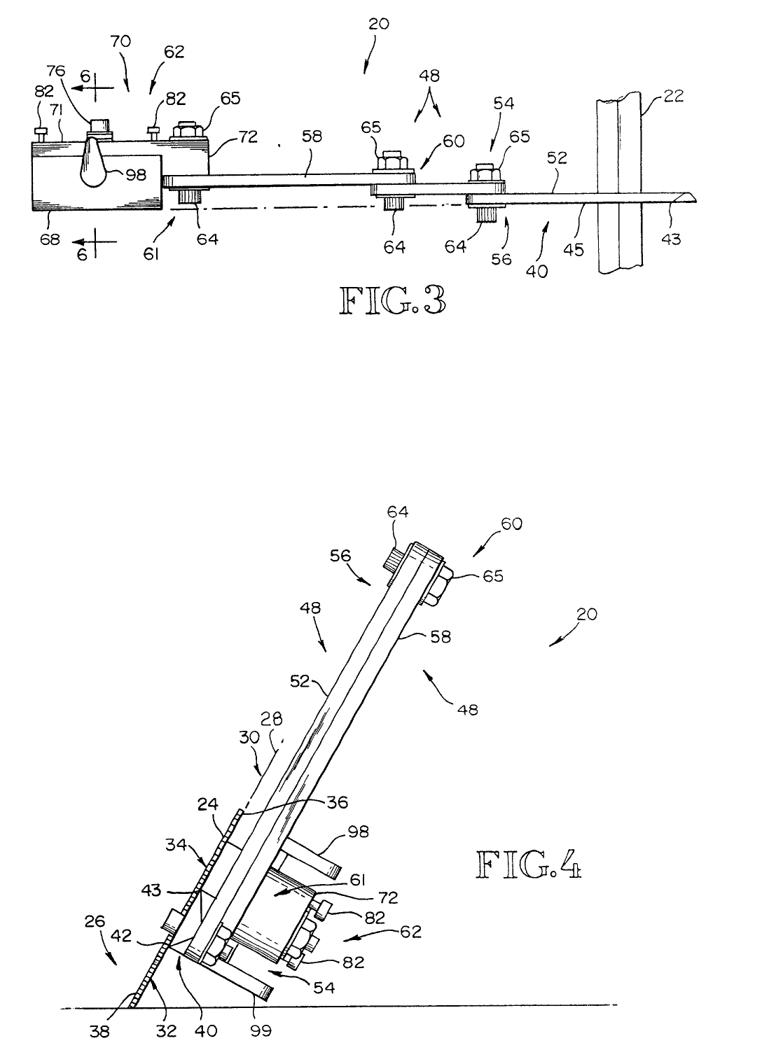

Connecting the alignment head 40 to the saw blade 24 is the support arm 48. As illustrated in FIGS. 1 through 7, the support arm 48 comprises several components pivotally linked together thereby enabling the alignment tool 20 to be extended and retracted. Specifically, the support arm 48 includes a first link 52 having a head end 54, pivotally connected to the alignment head 40, and a pivot end 56. Similarly, a second link 58 having a supporting end 60, pivotally connected to the pivot end 56 of the first link 52 is provided. At the opposing end of the second link 58 is a supported end 61 which is pivotally connected to a magnetic assembly 62. In the preferred embodiment, the first and second links 52 and 58 are constructed from 3/16 inch thick by 1 inch wide steel bar. Each link being approximately 6 to 7 inches long.

The magnetic assembly 62, in turn, magnetically engages and attaches to the saw blade surface 32. With this arrangement, the alignment head 40 can pivot and move from a first extended position (FIGS. 1, 3, 5 and 16) where the alignment head 40 is away from the saw blade 24, adjacent the workpiece 22 for aligning the same to the alignment edge 42, to a second retracted position where the alignment head 40 is adjacent the saw blade 24 (FIG. 2). Importantly, each pivot connection between components as noted above, defines a pivot axis (not illustrated) that is substantially at a right angle (90 degrees) to the plane defined by each parallel saw blade surface 32-34. In this way, when the alignment head 40 is moved from the first extended position to the second retracted position, or any position in-between, each component moves in a plane parallel to the saw blade surfaces. Accordingly, the alignment edges 42-43 can communicate the exact position or plane of the saw blade 24 in relation to the workpiece.

It should be noted that the pivot connections of the alignment head 40, the first link 52, the second link 58 and magnetic assembly 62 are facilitated by a plurality of alike, readily available ¼ inch bolts 64, ¼ inch nylock nuts 65 received thereon, regular washers 67 and spring washers 66 as illustrated.

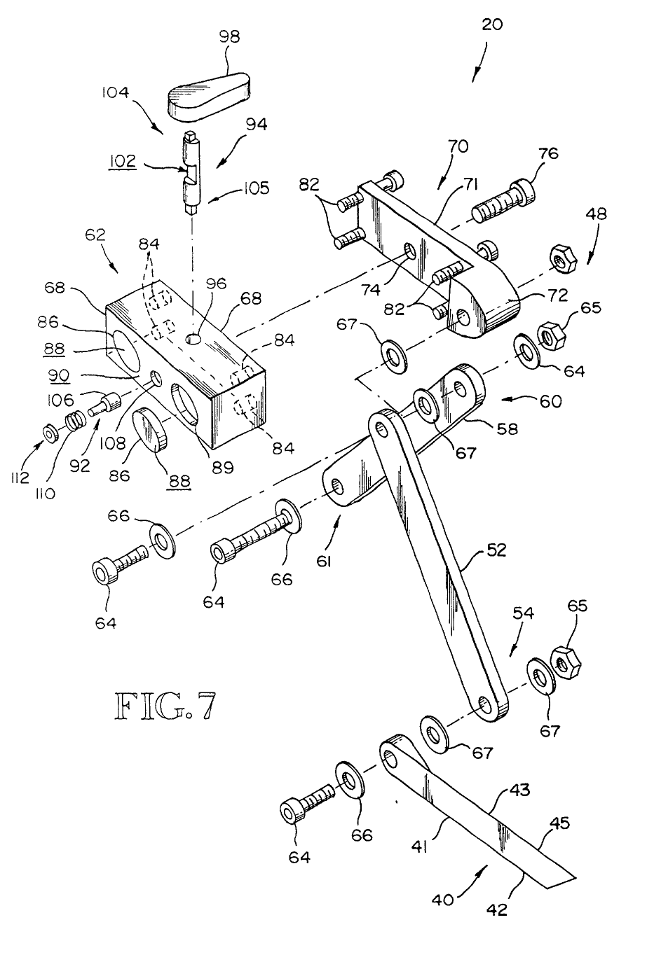

Directing attention to FIG. 7, an exploded view of the magnetic assembly 62 is illustrated showing the parts thereof. Centrally disposed is a base 68 and an adjacently disposed support plate 60. The support plate 70 is formed from a solid piece of aluminum to define an adjustment plate 71 and an integrally formed support head 72. The support head 72 comprises a bore 74 through which a bolt 64 secures the supported end 61 of the second link 58 thereto as illustrated in FIGS. 1 through 4. Importantly, the thickness of the base 68 is such that it precisely compensates for the thickness of the links 52 and 58 in combination with the thickness of the washers 66 and 67 along with the thickness of the support head 72. In this way, the base surface 90 defines a plane that is in-line with, and parallel to, the alignment edges 42-43 wherein the adjustment screws 82 (described below) can be adjusted to insure the precision of alignment of the alignment edges 4243 to the base surface 90.

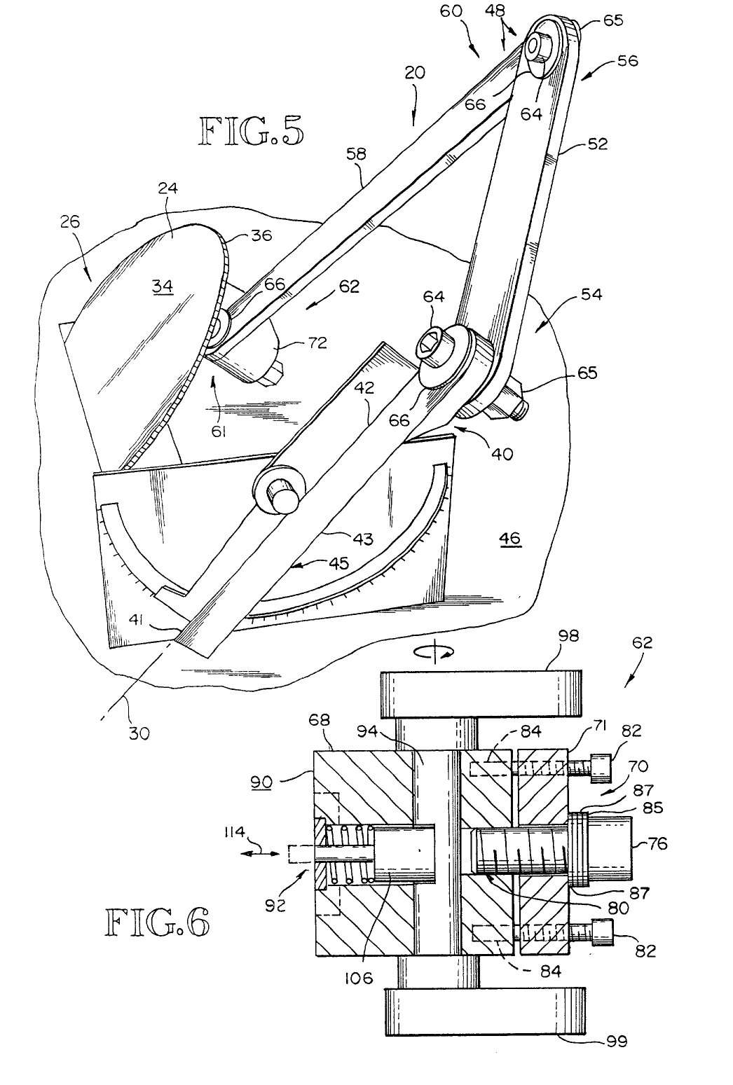

To enable the user to precisely adjust the alignment head 40, so that the alignment edges thereof lies precisely in (and parallel to) the saw blade cutting plane 30, the support plate 70 is adjustable in relation to the base 68. Specifically, in order to adjustably secure the support plate 70 to the base 68, a centrally disposed coupling bolt 76 is directed through bore 74 disposed on the adjustment Plate 71. Coupling bolt 76 threadably engages a threaded bore 80 disposed through a central portion of the base 68. In addition, four alike spaced adjustment screws 82 threadedly engage the adjustment Plate 71 as illustrated in FIGS. 6 and 7. The adjustment screws 82 extend through the adjustment plate 71 into alike opposing receiving bores 84 that extend part way through base 68. The ends of the adjustment screws 82 each extend to the bottom of the receiving bores 84. In this way, the plane of the support plate 70 can be adjusted relative to the base 68 by turning, i.e., individually adjusting the adjustment screws 82. For this purpose, a spring washer 85 disposed between two alike flat washers 87 is positioned about the coupling bolt 76 as illustrated in FIG. 6. This arrangement biases or urges the adjustment plate 71 toward the base 68 as the coupling bolt 76 is tightened toward the base 68. Accordingly, the spring washer 85 enables small adjustments in the adjustment screws 82 without having to adjust the coupling bolt 76 thereby securing the alignment head in proper position in relation to the saw blade 24.

In order to removably mount the magnetic assembly 62 to the saw blade 24, two alike substantially round magnetic elements 86 are disposed within similarly sized round spaced-apart holes/counterbores 89. In the preferred embodiment, the magnetic elements 86 are set with an adhesive so that the outside magnetic surface 88 is substantially flush with the planar base surface 90.

To facilitate easy removal of the magnetic assembly 62 from the saw blade 24, a release pin 92 is employed. For this purpose, a round cam pin 94 is disposed through bore 96 and is sized so that each end 104-105 thereof extends beyond the base 68 wherein opposing release handles 98-99 can securably engage the opposing ends 104-105 to enable a user to rotate the round cam pin 94. A cam surface 102 is centrally formed on the cam pin 94 by the removal of a portion thereof. The cam surface 102 provides a seat to receive the release pin head 106 which is disposed through bore 108. Bore 108 extends through base 68 as best illustrated in FIG. 6.

To maintain the release pin 92 in proper position, i.e., to insure that the pin head 106 is seated against cam surface 102, a spring 110 is disposed between the pin head 106 and a retaining collar 112. The outside diameter of the retaining collar 112 is substantially the same diameter as bore 108 and is fixed flush with the base surface 90 by an adhesive or other appropriate means. In this way, the user can rotate the cam pin 92 by turning the release handle which in turn extends the release pin 92 as illustrated by arrow 114. This extending action forces the base 68 away from the saw blade 24 thereby separating the same for removal of the alignment tool 20.

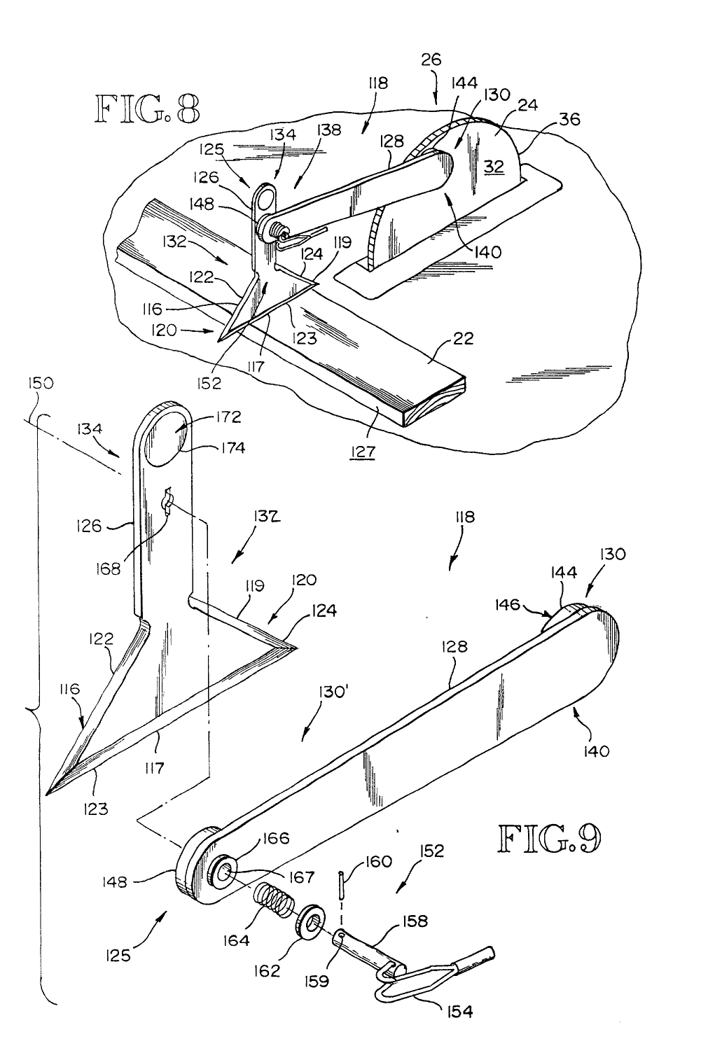

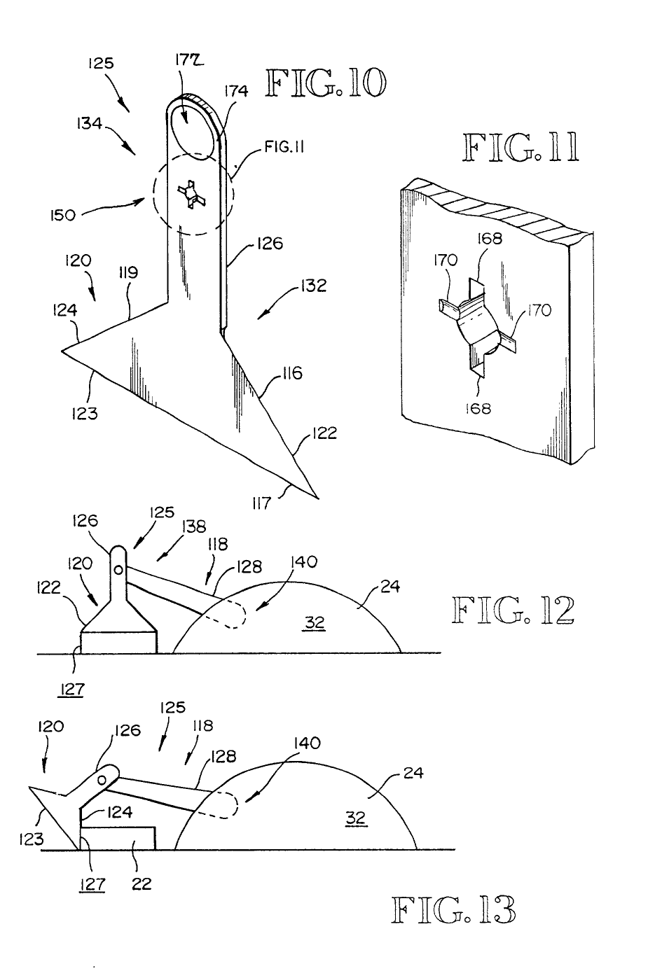

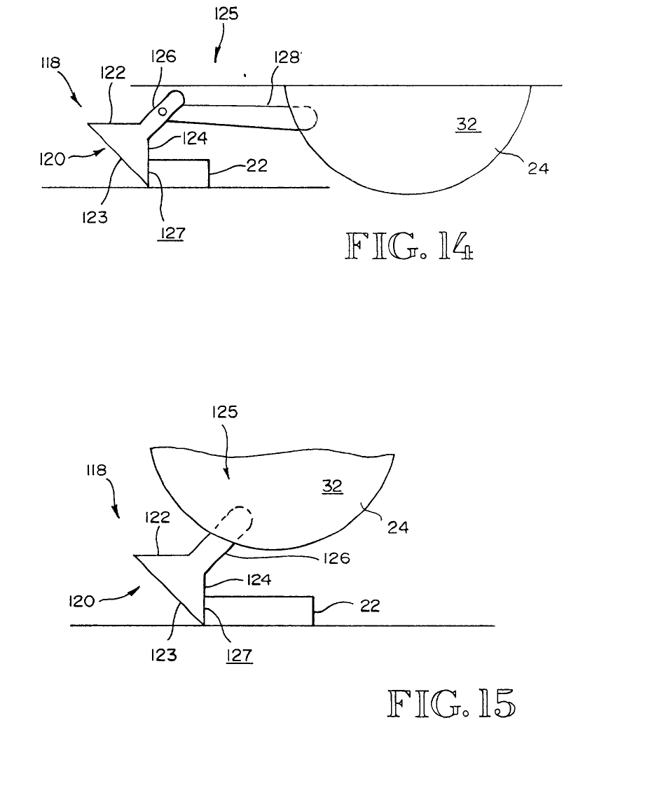

Turning now to FIGS. 8 through 15, an alternate embodiment is illustrated showing an alignment tool 118 having removable/separable components that allow the user to adapt to various saw tool and workpiece configurations. Included therein is a alignment head 120 having three alignment elements 116, 117 and 119 that define respectively alignment edges 122-124. Alignment edges 122-124 are symmetrically disposed in a single plane about the alignment head 120 and extend in opposing divergent directions. In addition, each edge thereof is straight even though that some situations may call for a curved edge (not illustrated). In the alternate embodiment, two opposing alignment edges 122 and 124 form an angle of approximately 30 degrees to alignment edge 123 which is centrally disposed between alignment edges 122 and 124. It should be noted that this arrangement of alignment edges on the alignment head 120 could be modified substantially in number or placement to improve the performance of the alignment tool 118 for some situations, without departing from the purpose and design of the alignment head 120 or alignment tool 118.

Similar to the preferred embodiment, the alignment tool 118 comprises a support arm 125 that includes two links: a first link 126, a second link 128, and a magnetic assembly 130. In the alignment tool 118, however, the first link 126 includes a head end 132 that is fixed to the alignment head 120, i.e., integrally formed therewith. In addition, the first link 126 includes a pivot end 134 that is detachable from the supporting end 138 of the second link 128. it should be noted that the pivot end 134 is pivotally connected to the supporting end 138. Opposing the supporting end 138 is a supported end 140 to which a magnetic assembly 130 is attached. The magnetic assembly 130 includes a round hollow spacer 144 sized to receive a magnetic element 146 (not illustrated) which secures the alignment tool 118 to the saw blade 24.

Importantly, a similar round spacer 148 is co-axially disposed about the pivot axis 150 defined by the pivotal connection between the pivot end 134 and the supporting end 138. Moreover, as illustrated in FIGS. 9 and 15, the pivot end 134 of the first link 126 includes a magnetic assembly 130 that includes a magnetic element 146 (not illustrated). The round spacer 148 is approximately the same thickness as the round magnetic assembly so that the alignment edges 122124 are properly positioned, substantially on the saw blade cutting plane 30 when the alignment tool 118 is magnetically attached to the saw blade 24.

Directing attention to FIG. 9, the exploded illustration shows an alignment tool 118 wherein the first link 126 includes a pivot end 134 that is detachable from the supporting end 138 of the second link 128. For this purpose, a toggle clamp assembly 152 is provided to pivotally connect the first link 126 to the second link 128. Specifically, the toggle clamp assembly 152 comprises a “C” shaped toggle clamp 154 attached to one end of a pivot pin 158. The pivot pin 158 is guided respectfully though washer 162, spring 144, washer 166 and then through bore 167 which extends through the second link 128 and the spacer 148. With this arrangement, a retaining pin 160 is positioned through a bore on the opposing end of the pivot pin 158.

Importantly, the retaining pin 160 prevents the pivot pin 160 from sliding back through bore 167, as well as serving to urge the first and second links together. For example, pivotal attachment of the first link 126, to the second link 128 is accomplished by extending the retaining pin 160 completely through pin slot 168 which is shaped and sized to receive the pivot pin 158—retaining pin 160 combination. After the pivot pin 158 is so received, the user can turn the same 90 degrees so that the retaining pin 160 seats in pin lock grooves 170 (FIG. 11). Accordingly, the spring 164 urges the first and second links together wherein additional retaining pressure can be exerted by moving/rotating the toggle clamp 154 outward to further compress spring 164 (not illustrated). It should be understood that the construction of a toggle clamp assembly 152, as noted above, represents only one example of pivotally connecting the first link 126 to the second link 128, and that many other techniques or methods exist to produce equally satisfactory results.

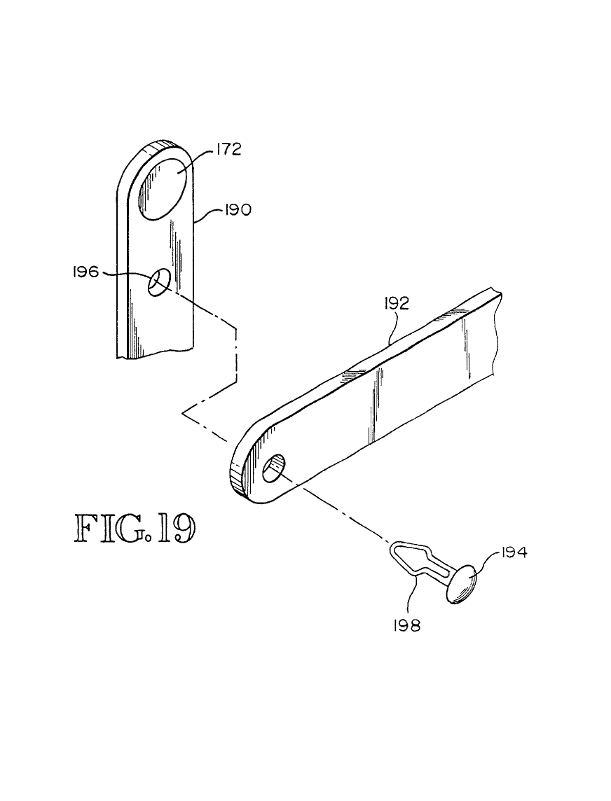

For example, FIG. 19 illustrates a first link 192 pivotally connected to a second link 192 via a key hole panel rivet 194. For connection purposes, the panel rivet 194 comprises rivet expansion sides 198 that engage a counter sunk bore 196.

With the construction of alignment tool 118 as noted above, the first link 126 and be separated from the second link 128, and used alone as illustrated in FIG. 15. For this purpose, a magnetic 172 is received into bore 174 which allows the user to magnetically fix the first link 128 directly to a saw blade 24. This set-up is particularly useful when the user is working with a compound miter saw/chop saw.

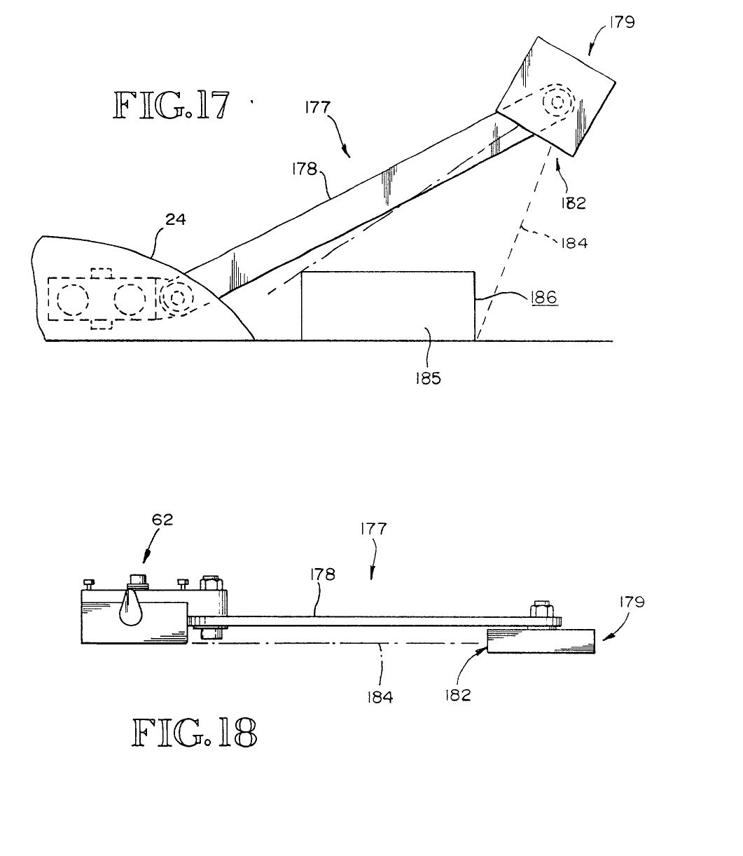

Directing attention to FIGS. 17 and 18, another alternate embodiment alignment tool 118 is illustrated wherein the alignment head 179 thereof comprises a laser 182 to define a plane of light which is the alignment element 184. For example, laser 182 is mounted to a support arm of the type described in the preferred embodiment. The laser is disposed and mounted so that it emits a plane of light, denoted by the broken lines, i.e., alignment element 184 that defines a plane which is co-planar with the saw blade cutting plane 30. In this way, the user can arrange the workpiece so that the scribe lines thereon fall precisely within the plane of light which is the alignment element 184.

Finally, it should be understood that one of the important aspects of the present invention and the alternated embodiments thereof is that it enables a user to place an alignment element (alignment element 41 in FIG. 16, and alignment element 184 in FIG. 17), for example, on a back surface 39 or back surface 186 as best seen in FIG. 17. As illustrated, a back surface 186 is a surface which is not viewable, i.e., out of view from any point between the back surface 186 and the saw blade 24. For this situation to occur, the back surface 186 is generally vertical in relation to the work surface 46, or at an angle of less than 90 degrees, for example if the back surface tilts away from the saw blade 24 (not illustrated).

Having illustrated and described the principles of my invention in a preferred embodiment thereof, it should be readily apparent to those skilled in the art that the invention can be modified in arrangement and detail without departing from such principles. I claim all modifications coming within the spirit and scope of the accompanying claims.

What is claimed is:

1. An alignment tool for precisely aligning a workpiece to a saw blade so that as the saw blade and the workpiece are brought together, the predetermined plane of cut through the workpiece, as defined by scribe lines marked on one or more surfaces thereof, is aligned with the saw blade cutting plane as defined by the leading cutting edge of the saw blade, the alignment tool comprising:
an alignment head disposed in spaced relation to the saw blade, adjacent the workpiece;
an elongated alignment element projecting from the alignment head for engagement with the workpiece, along the predetermined plane of cut through the workpiece;
a support arm disposed between the saw blade and the alignment head for attachment with the alignment head to adjustably support the same in spaced relation to the saw blade such that the alignment head can be adjusted in a direction parallel with the saw blade cutting plane;
means for removably mounting the support arm from the saw blade; and
wherein the alignment element is oriented, in relation to the alignment head, to project on the saw blade cutting plane, and extend along the saw blade cutting plane when the support arm is mounted to the saw blade, so that as the alignment element is precisely aligned with the predetermined plane of cut through the workpiece, the saw blade cutting plane is thereby aligned with the predetermined plane of cut.

2. A workpiece alignment tool as recited in claim 1 wherein the alignment element comprises a laser that projects a plane of light oriented so that the plane of light is coplanar with the saw blade cutting plane wherein as the plane of light is directed toward the workpiece, the plane of light indicates the saw blade cutting plane on the workpiece.

3. A workpiece alignment tool as recited in claim 2 wherein the alignment head is rotatable in relation to support arm to align the plane of light from the laser so that a portion thereof is directed back from laser toward the saw blade for engagement with a back surface of the workpiece.

4. A workpiece alignment tool as recited in claim 2 wherein the alignment head is rotatingly connected to the support arm to rotate about an axis perpendicular to the saw blade cutting plane so that as the alignment head is rotated, the plane of light projected from the laser remains coplanar with the saw blade cutting plane.

5. A workpiece alignment tool as recited in claim 1 wherein the alignment element comprises at least one straight alignment edge for engagement with the workpiece along the predetermined plane of cut through the same.

6. A workpiece alignment tool as recited in claim 5 wherein the alignment element comprises a plurality of alignment edges.

7. A workpiece alignment tool as recited in claim 6 wherein the alignment head is fixedly attached to the support arm.

8. A workpiece alignment tool as recited in claim 6 wherein the alignment head comprises three coplanar alignment edges that extend in opposing divergent directions.

9. A workpiece alignment tool as recited in claim 1 wherein the support arm comprises:
an elongate first link having a head end attached to the alignment head and an opposing pivot end, and
an elongate second link having a pivot end pivotally connected to the pivot end of the first link, and an opposing supported end mounted to the saw blade.

10. A workpiece alignment tool as recited in claim 9 wherein the supported end comprises a magnetic assembly for magnetically mounting the same to the saw blade.

11. A workpiece alignment tool as recited in claim 9 wherein the head end of the first elongate link is pivotally attached to the alignment head, for rotation about an axis perpendicular to the saw blade cutting plane, wherein the alignment head can pivot from a first extended position where the alignment head is adjacent the workpiece for aligning the same to an alignment edge, to a second retracted position where the alignment head is adjacent the saw blade.

12. A workpiece alignment tool as recited in claim 1 wherein the means for removably mounting the support link to the saw blade comprises a magnetic element.

13. A workpiece alignment tool as recited in claim 12 wherein the magnetic element is adjustable in relation to the saw blade such that the support arm can rotate about an axis parallel with the saw blade cutting plane.

14. A method for making an alignment tool for precisely aligning a workpiece to a saw blade so that as the saw blade and the workpiece are brought together, the predetermined plane of cut through the workpiece, as defined by scribe lines marked on one or more surfaces thereof, is aligned with the saw blade cutting plane as defined by the leading cutting edge of the saw blade, the method comprising the steps:
providing an alignment head disposed in spaced relation to the saw blade, adjacent the workpiece;
providing an elongated alignment element that projects from the alignment head for engagement with the workpiece, along the predetermined plane of cut through the workpiece;
placing a support arm between the saw blade and the alignment head for attachment with the alignment head to adjustably support the same in spaced relation to the saw blade such that the alignment head can adjusted in a direction parallel with the saw blade cutting plane;
removably mounting the support arm from the saw blade; and
orienting the alignment element, in relation to the alignment head, to project on the saw blade cutting plane, and extend along the saw blade cutting plane when the support arm is mounted to the saw blade, so that as the alignment element is precisely aligned with the predetermined plane of cut through the workpiece, the saw blade cutting plane is thereby aligned with the predetermined plane of cut.

15. A method for making an alignment tool as recited in claim 14 further comprising the step of providing a laser for the alignment element that projects a plane of light oriented so that the plane of light is coplanar with the saw blade cutting plane wherein as the plane of light is directed toward the workpiece, the plane of light indicates the saw blade cutting plane on the workpiece.

16. A method for making an alignment tool as recited in claim 15 wherein the alignment head is adjustable to align the plane of light from the laser so that a portion thereof is directed back from laser toward the saw blade for engagement with a back surface of the workpiece.

17. A method for making an alignment tool as recited in claim 15 wherein the alignment head is rotatingly connected to the support arm to rotate about an axis perpendicular to the saw blade cutting plane so that as the alignment head is rotated, the plane of light projected from the laser remains coplanar with the saw blade cutting plane.

18. An alignment tool for precisely aligning a workpiece to a saw blade so that as the saw blade and the workpiece are brought together, the predetermined plane of cut through the workpiece, as defined by scribe lines marked on one or more surfaces thereof, is aligned with the saw blade cutting plane as defined by the leading cutting edge of the saw blade, the alignment tool comprising:
an alignment head disposed in spaced relation to the saw blade, adjacent the workpiece;
at least one elongated alignment edge projecting from the alignment head for engagement with the workpiece, along the predetermined plane of cut through the workpiece;
a support arm disposed between the saw blade and the alignment head for attachment with the alignment head to adjustably support the same in spaced relation to the saw blade such that the alignment head can be adjusted in a direction parallel with the saw blade cutting plane;
means for removably mounting the support arm from the saw blade; and
wherein the alignment edge is oriented, in relation to the alignment head, to project on the saw blade cutting plane, and extend along the saw blade cutting plane when the support arm is mounted to the saw blade, so that as the alignment edge is precisely aligned with the predetermined plane of cut through the workpiece, the saw blade cutting plane is thereby aligned with the predetermined plane of cut.

19. A workpiece alignment tool as recited in claim 18 wherein the alignment head is fixedly attached to the support arm, and comprises three coplanar alignment edges projecting from the alignment head with each alignment edge extending in opposing divergent directions.

20. A workpiece alignment tool as recited in claim 18 wherein the support arm comprises:
an elongate first link having a head end attached to the alignment head and an opposing pivot end, and
an elongate second link having a pivot end pivotally connected to the pivot end of the first link, and an opposing supported end mounted to the saw blade.
